(19) United States
(12) Patent Application Publication
(10) Pub. No.: US 2026/0247090 A1
(43) Pub. Date: Aug. 20, 2026

(54) METHOD FOR MULTICHANNEL AUDIO RECONSTRUCTION AND SPEAKER SYSTEM USING THE METHOD

(71) Applicant: HARMAN INTERNATIONAL INDUSTRIES, INCORPORATED, Stamford, CT (US)

(72) Inventors: Hongyi ZHU, Shenzhen, Guangdong (CN); Jianwen ZHENG, Shenzhen, Guangdong (CN); Hongfei ZHOU, Shenzhen, Guangdong (CN)

(73) Assignee: HARMAN INTERNATIONAL INDUSTRIES, INCORPORATED, Stamford, CT (US)

(21) Appl. No.: 19/471,010

(22) PCT Filed: Apr. 18, 2023
(86) PCT No.: PCT/CN2023/088957

§ 371 Date: Sep. 30, 2025

(51) Int. Cl. H04S 5/00; G10L 21/0272; H04R 5/02

(52) U.S. Cl. CPC H04S 5/005; G10L 21/0272; H04R 5/02

(57) ABSTRACT

This disclosure provides a method of multichannel audio reconstruction for a speaker system and the speaker system using the method. The method may comprise: receiving stereo audio; performing vocal extraction on the stereo audio and outputting a stereo vocal signal and a stereo non-vocal signal; performing primary and ambience extraction (PAE) based rendering on the stereo vocal signal and the stereo non-vocal signal, respectively, to obtain a rendered vocal output and a rendered non-vocal output; and mixing the rendered vocal output and the rendered non-vocal output to generate the multichannel audio.

### TECHNICAL FIELD

The present disclosure relates to audio processing, and specifically relates to an optimized method for multichannel audio reconstruction and a speaker system using the method.

### BACKGROUND

Home theater has become more and more popular, as multichannel sound reproduction can create a more immersive sound field for users with a realistic front soundstage and a natural sense of envelopment, compared with mono or stereo reproduction. Now many speaker systems (such as JBL speakers) have physical multiple channels to support multichannel sound reproduction, such as soundbars with multi-beam or portable speakers featured with “party mode”.

However, in home scenarios, it is more common for users to enjoy music which is almost stereo material. The most common and easiest way to broadcast such stereo material is duplicating and transmitting the stereo/mono signal to each speaker, which is used in the “party mode” feature of JBL speakers. This produces a louder but unnatural sound field which is also a waste of a multichannel system. Thus, it's a natural desire to re-render stereo audio to multichannel audio such that the benefits of multichannel reproduction can be attained, like JBL soundbars equipped with matrix decoder (JBL NSP, Dolby atmos, DTS). Although matrix decoders have been common for more than forty years, there are still some challenges in improving the sense of envelopment and creating more realistic proximity.

Furthermore, some JBL speakers are featured with “karaoke mode” for users by playing non-vocal music, but most of them are all limited to mono or stereo reproduction. It may be a trend to expand “karaoke mode” to multichannel sound reproduction for better entertainment.

The early traditional matrix decoder is designed to adjust the gain of each channel by analyzing the amplitude and phase information of the input signal. This kind of matrix decoding technology has some problems, such as crosstalk caused by low degree of channel separation and inaccurate localization of sound images. To solve the above problems, a new matrix decoding method is gradually derived. The key idea of the matrix coding method is to separate the direct sound and reverberation sound contained in the stereo signal based on time-frequency transformation. The direct sound can be directly played through matrix decoding, enabling users to localize the sound source, so the source localization is better than that of the traditional matrix decoder. The reverberation sound is independent of the direct sound, and it can be distributed to surround channels to provide high quality spaciousness.

In practical scenarios, most of the stereo materials are music signals dominated by vocals. Therefore, when extracting direct sound from the stereo signal, the directional musical instrument may be merged by human voice, leading to the inconspicuous separation of musical instrument sound images. For example, the JBL NSP decoder extracts primary and ambience components according to coherence analysis between left and right channel, then puts the primary extracted component to the front channels (Left, Right and Center channels with adjustable gain), and distributes the ambience component to surround channels. Such a strategy can create a focused center image with a nice immersive sound field. However, there are still two drawbacks for the NSP decoder. Firstly, musical instruments are almost merged in the center channel losing their spatial distribution, thus the width of front soundstage is limited. Secondly, some primary residue remains in ambience parts which may sound a bit unnatural due to limited degree of separation.

Thanks to the development of machine learning, different sound sources (such as vocals, bass, plano, etc.) can be extracted with a high degree of separation. Thus, the separated audio objects can be processed and remixed into multichannel audio. However, due to the large number of databases (regarding vocal data and sound data of various musical instruments) required for model training, a limited number of sound sources can be separated. Therefore, there is still a long way for this technical proposal of being widely used.

Therefore, improved technology is needed to overcome the above defects.

### SUMMARY

According to one aspect of the disclosure, a method of multichannel audio reconstruction for a speaker system is provided. The method may comprise receiving stereo audio; performing vocal extraction on the stereo audio and outputting a stereo vocal signal and a stereo non-vocal signal; performing primary and ambience extraction (PAE) based rendering on the stereo vocal signal and the stereo non-vocal signal, respectively, to obtain a rendered vocal output and a rendered non-vocal output; and mixing the rendered vocal output and the rendered non-vocal output to generate the multichannel audio.

According to another aspect of the present disclosure, a speaker system is provided. The speaker system may comprise a memory configured to store instructions; and a processor coupled to the memory. The processor may be configured to perform the instructions to receive stereo audio; perform vocal extraction on the stereo audio and outputting a stereo vocal signal and a stereo non-vocal signal; perform primary and ambience extraction (PAE) based rendering on the stereo vocal signal and the stereo non-vocal signal, respectively, to obtain a rendered vocal output and a rendered non-vocal output; and mix the rendered vocal output and the rendered non-vocal output to generate the multichannel audio.

According to yet another aspect of the present disclosure, a non-transitory computer-readable storage medium comprising computer-executable instructions which, when executed by a computer, causes the computer to perform the method disclosed herein.

### BRIEF DESCRIPTION OF THE DRAWINGS

FIG. 1 illustrates a schematic diagram of multichannel audio generation according to one or more embodiments of the present disclosure.

FIG. 2 illustrates a schematic diagram of the PAE based rendering method performed according to one or more embodiments of the present disclosure.

FIG. 3 illustrates an example of an N-channel reproduction system composed of N speakers.

FIG. 4 illustrates the rendering of the ambient component according to one or more embodiments of the present disclosure.

To facilitate understanding, identical reference numerals have been used, where possible, to designate identical elements that are common to the figures. It is contemplated that elements disclosed in one embodiment may be beneficially utilized in other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION OF THE PREFERRED EMBODIMENTS

Examples will be provided below for illustration. The descriptions of the various examples will be presented for purposes of illustration, but are not intended to be exhaustive or limited to the embodiments disclosed. Many modifications and variations will be apparent to those of ordinary skill in the art without departing from the scope and spirit of the described embodiments.

The disclosure provides a new approach for multi-channel audio reconstruction, which adopts a new method to expand stereo audio signals into multi-channel audio signals, so that the speaker system having physical multi-channels may be utilized to the maximum extent and can provide a wider front soundstage and more immersive experience. This is achieved by using an optimized method of multichannel audio reconstruction based on a combination of a preprocessing of the stereo audio (i.e., vocal extraction) and a PAE (primary and ambience extraction) based rendering. The preprocessing part helps to eliminate the influence between vocals and other primary components, which ensures the localization stability of vocals and other instruments. The PAE based rendering part can provide a wider front soundstage and more immersive experience. The approach will be explained in details with reference to FIGS. 1-4 as follows.

FIG. 1 illustrates a schematic diagram of multichannel audio generation according to one or more embodiments of the present disclosure. The proposed method of multichannel audio generation may be implemented based on stereo audio preprocessing combined with PAE based rendering, which may be realized by the preprocessing module 102 and the rendering module 104 shown in FIG. 1, respectively. Each of the preprocessing module 102 and the rendering module 104 may be a software or firmware module included in the speaker system.

In some embodiments, the preprocessing module 102 performs vocal extraction on the received stereo audio signal in real-time to separate the received stereo audio into a vocal segment and a non-vocal segment (also called as a stereo vocal signal and a stereo non-vocal signal hereafter). In some examples, the preprocessing module 102 performs the vocal extraction using some existing techniques, for example, blind source separation such as ICA (Independent Component Analysis), NMF (Nonnegative Matrix Factorization) and so on. In some examples, the preprocessing module 102 performs the vocal extraction using machine-learning preprocess, for example, using the machine-learning preprocess method disclosed in WO2022082607A1 (“VOCAL TRACK REMOVAL BY CONVOLUTIONAL NEURAL NETWORK EMBEDDED VOICE FINGER PRINTING ON STANDARD ARM EMBEDDED PLATFORM”). Since the preprocess performed by the preprocessing module 102 only separates the stereo audio into two kinds of signals, namely vocal and non-vocal signals, without further separating sound signals of various musical instruments from the stereo audio, there is no need to include a large number of databases of various types of sound data, thereby greatly improving the practicability of the multi-channel audio reconstruction approach proposed in this disclosure.

In some embodiments, the rendering module 104 may receive signals output from the preprocessing module 102 and render the received signals based on the PAE in time-frequency domain. In some embodiments, the rendering module 104 may include two sub-modules 1042, 1044 to perform the PAE based rendering on the stereo vocal signal and stereo non-vocal signal, respectively. For example, the sub-module 1042 may receive the extracted stereo vocal signal, and perform the PAE on the stereo vocal signal to obtain primary component and ambience component of the stereo vocal signal. The sub-module 1042 may further render the primary component and the ambience component of the stereo vocal signal respectively. Then, the sub-module 1042 may output the rendered vocal output, which may include vocal signals assigned to at least one speaker or channel of the speaker system. Likewise, the sub-module 1044 may receive the extracted stereo non-vocal signal, and perform the PAE on the stereo non-vocal signal to obtain primary component and ambience component of the stereo non-vocal signal. The sub-module 1044 may further render the primary component and the ambience component of the stereo non-vocal signal respectively. Then, the sub-module 1044 may output the rendered non-vocal output, which may include non-vocal signals assigned to at least one speaker or channel.

Then, the rendered vocal output from the sub-module 1042 and the rendered non-vocal output from the sub-module 1044 may be mixed to generate the multichannel audio.

In some embodiments, a judgment module (not shown in FIG. 1) can be set between the preprocessing module 102 and the rendering module 104 to determine whether the speaker system operates in a party mode or a karaoke mode. For example, if the speaker system is operated to switch from the party mode to the karaoke mode, it can be controlled so that only the module 1044 performs PAE based rendering since non-vocal music is playing in the karaoke mode. On the other hand, if the speaker system is operated to switch from the karaoke mode to the party mode, it can be controlled so that both sub-modules 1042 and 1044 perform PAE based rendering respectively. Based on the above framework of the multichannel audio generation method shown in FIG. 1, there is an additional advantage that the speaker system can realize multi-channel audio reconstruction in both “party mode” and “karaoke mode” in an easier way.

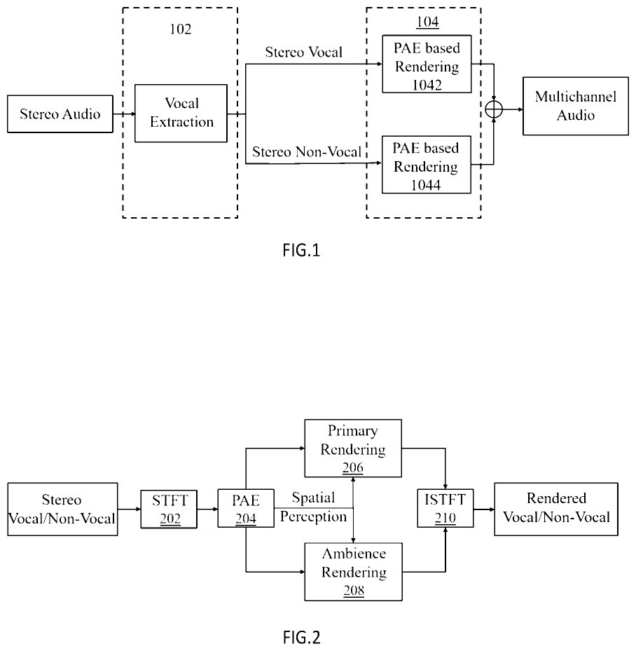

FIG. 2 illustrates a schematic diagram of the PAE based rendering method performed according to one or more embodiments of the present disclosure. The rendering process shown in FIG. 2 may be applicable to both the stereo vocal signal and the stereo non-vocal signal. In other words, the rending process including the processes at blocks 202-210 may be performed by the sub-module 1042 and the sub-module 1044 in FIG. 1, respectively.

In some embodiments, at block 202, for example, the stereo vocal/non-vocal signal output from the preprocessing module 102 may be received and may be transformed with Short-Time Fourier Transform (STFT). At block 204, the PAE may be performed based on the transformed stereo vocal/non-vocal signal. The details of the PAE will be illustrated as follows.

Usually, stereo audio can be roughly divided into two categories according to its recording form, i.e., studio recording and live recording. In the case of studio recording, different sound sources are individually recorded and mixed, and finally synthetic ambient sound components are added to form a two-channel signal. And the live recording needs to capture all the sound source signals through the distributed arrangement of multiple microphones in the field, which naturally include the environmental sound information. Regardless of which recording method is used, the stereo audio can be regarded as the combination of the primary component (direct sound) and the ambient component (reverberation sound). In other words, either of the extracted vocal and non-vocal audio can be regarded as the combination of the primary component and ambient component.

Therefore, for a stereo audio input (either of the stereo vocal audio and the stereo non-vocal audio) x(t)=[x_{L}(t), x_{R}(t)], it can be represented in time-frequency domain as follows.

$${X}_{L} ( b , k ) = {G}_{L} p ( b , k ) + {a}_{L} ( b , k ) \qquad ( 1 )$$

$${X}_{R} ( b , k ) = {G}_{R} p ( b , k ) + {a}_{R} ( b , k )$$

p represents the primary component, G_{L/R} represents the gain value of primary component in the left/right channel, a_{L/R} represents the ambience component in the left/right channel. The expression of Gyp represents the product of G_{L} and p. Similarly, G_{R}p represents the product of G_{R} and p. The variables b and k denote the time and band index, respectively. To simplify the expression form, (b, k) is ignored in the subsequent analysis in this disclosure. Also, for the sake of simplicity, the expression of the stereo audio input x(t) may represent either the stereo vocal signal or the stereo non-vocal signal, which is just for illustration the principle of the PAE.

The core of the matrix decoder is to separate the primary component and the ambient component, that is, p, a_{L/R} in the signal model shown in equation (1). To solve this problem, the separation matrix WϵR^{2×2} is defined to extract the primary component, and it can be solved by minimizing the error between the extracted component and the target primary component, which can be formed as an optimization problem as below.

$${min}_{W} {‖ [ \begin{matrix}{G}_{L} p \\ {G}_{R} p\end{matrix} ] - W [ \begin{matrix}{G}_{L} p + {a}_{L} \\ {G}_{R} p + {a}_{R}\end{matrix} ] ‖}_{2} \qquad ( 2 )$$

The solution of the W above can be optimized by different convex optimization methods, such as the least square method. Therefore, the primary and ambient components can be represented as follows.

$$[ \begin{matrix}{G}_{L} p \\ {G}_{R} p\end{matrix} ] ≅ W [ \begin{matrix}{X}_{L} \\ {X}_{R}\end{matrix} ] \qquad ( 3 )$$

$$[ \begin{matrix}{a}_{L} \\ {a}_{R}\end{matrix} ] = [ \begin{matrix}{X}_{L} \\ {X}_{R}\end{matrix} ] - W [ \begin{matrix}{X}_{L} \\ {X}_{R}\end{matrix} ]$$

As shown in FIG. 2, the primary component and the ambient component obtained at block 204 may be rendered at block 206 and block 208, respectively, based on spatial perception principles.

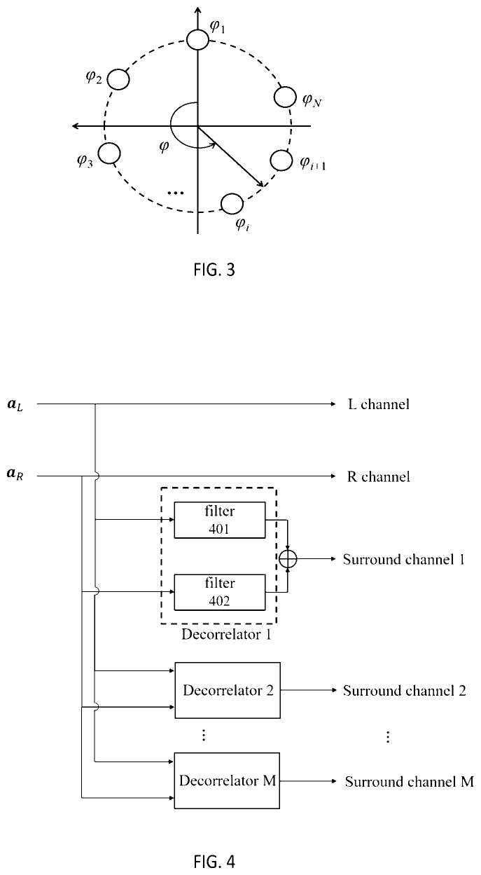

For the rendering of the primary component at block 206, a direction of a sound source is first needed to calculate based on spatial orientation information contained in the primary component. Based on the calculated direction of the sound source, the speakers used to reproduce the sound source may be determined. Then, the signals assigned to each speaker of the determined speakers should be calculated. The basic idea of such rendering is to use two adjacent speakers (or channels) to reproduce the sound source between the two adjacent speakers. For example, there exists a N-channel reproduction system composed of N speakers with azimuth φq=[φ₁, φ₂, . . . , φ_{N}] as shown in the FIG. 3. If the direction of a sound source is φϵ[φᵢ, φᵢ₊₁], which can be obtained by a gain estimation of the primary component

$$( φ = {tan}^{- 1} ( \frac{{G}_{L}^{2} - {G}_{R}^{2}}{2 {G}_{L} {G}_{R}} ) ) .$$

Then the speaker i and speaker i+1 can be used to reproduce the sound source in this direction, the assigned signals for the two speakers (or channels) labelled as pᵢ and pᵢ₊₁ should satisfy the principle of conservation of energy. So we define the reconstruction matrix G as the following equation (4).

$$G = [ \begin{matrix}{G}_{1} ( {φ}_{i 1} ) & {G}_{2} ( {φ}_{i 1} ) \\ {G}_{1} ( {φ}_{i 2} ) & {G}_{2} ( {φ}_{i 2} )\end{matrix} ] \qquad ( 4 )$$

wherein φᵢ₁=φ−φᵢ, φᵢ₂=φ−φᵢ₊₁; and G₁(φ)=cos (f(φ)), G₂(φ)=sin (f(φ)). f(φ) is a function of φ that can be used to modify values of G₁ and G₂ to control how much primary component is fed to each speaker/channel. Thus, f(φ) can affect the perception of the direction of the sound source.

Thus the pᵢ and pᵢ₊₁ can be calculated as equation (5).

$$[ \begin{matrix}{p}_{i} \\ {p}_{i + 1}\end{matrix} ] = inv ( \begin{matrix}{G}_{1} ( {φ}_{i 1} ) & {G}_{2} ( {φ}_{i 1} ) \\ {G}_{1} ( {φ}_{i 2} ) & {G}_{2} ( {φ}_{i 2} )\end{matrix} ) W [ \begin{matrix}{X}_{L} \\ {X}_{R}\end{matrix} ] \qquad ( 5 )$$

For the rendering of the ambient component at block 208, the goal thereof is to achieve a diffuse sound field, especially to generate ambience signals for surround channels. It is necessary to ensure that the ambient components in left channel and right channel (i.e., a_{L} and a_{R}) of the N-channel are uncorrelated. This can be realized by convolving the extracted ambience component a_{L} and the extracted ambience component a_{R} with respective recorded or simulated impulse responses (i.e., respective predetermined impulse responses). A schematic diagram of further decorrelation of the ambient components a_{L} and a_{R} is shown in FIG. 4. For example, M decorrelators are set for M surround channels. Each of the decorrelators may be implemented by two filters with respective recorded or simulated impulse response, such as filters 401 and 402 shown in FIG. 4 as an example. Filters 401 and 402 may have different predetermined impulse responses. For example, the extracted ambience component a_{L} is input to the filter 401 and the extracted ambience component a_{R} is input to the filter 402. Then, the output of the filter 401 and the output of the filter 402 may be mixed to generate the rendered ambience signal for Surround channel 1. It can be understood that each of decorrelators 2-M may be implemented as above.

Back to FIG. 2, at block 210, an Inverse Short-Time Fourier Transform (ISTFT) may be performed on the rendered primary signals and the rendered ambience signals.

Through the processes at blocks 202-210, the rendered vocal output may be obtained, wherein the rendered vocal output may include the rendered primary signals and the rendered ambience signals obtained based on the extracted stereo vocal signal. Also, through the processes at blocks 202-210, the rendered non-vocal output may be obtained, wherein the rendered non-vocal output may include the rendered primary signals and the rendered ambience signals obtained based on the extracted stereo non-vocal signal. It can understood that the rendered vocal output and the rendered non-vocal output themselves somewhat are multichannel outputs. For example, in the party mode, the rendered vocal output and the rendered non-vocal output may be mixed to generate the multichannel audio. In the karaoke mode, the rendered non-vocal output may be output as the multichannel audio. In some embodiments, the speaker system may comprise at least one control element that can be operated to control the speaker system to switch between the party mode and the karaoke mode.

It can be recognized that the discussed method above may be realized by a processor included in the speaker system. The speaker system may comprise a memory and a processor. The memory may be configured to store computer-readable instructions or codes for causing the processor to carry out the above said aspects of the present disclosure. The processor may be any technically feasible hardware unit configured to process data and execute software applications, including without limitation, a central processing unit (CPU), a microcontroller unit (MCU), an application specific integrated circuit (ASIC), a digital signal processor (DSP) chip and so forth.

The descriptions of the various embodiments have been presented for purposes of illustration, but are not intended to be exhaustive or limited to the embodiments disclosed. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module”, “unit” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective calculating/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the drawings illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

Clause 1. In some embodiments, a method of multichannel audio reconstruction for a speaker system comprising: receiving stereo audio; performing vocal extraction on the stereo audio and outputting a stereo vocal signal and a stereo non-vocal signal; performing primary and ambience extraction (PAE) based rendering on the stereo vocal signal and the stereo non-vocal signal, respectively, to obtain a rendered vocal output and a rendered non-vocal output; and mixing the rendered vocal output and the rendered non-vocal output to generate the multichannel audio.

Clause 2. The method according to clause 1, wherein the performing the PAE based rendering on the stereo vocal signal and the stereo non-vocal signal comprises: performing Short-Time Fourier Transform (STFT) on the stereo vocal signal and the stereo non-vocal signal to obtain the transformed stereo vocal signal and the transformed stereo non-vocal signal; performing the PAE on the transformed stereo vocal signal and the transformed stereo non-vocal signal to obtain the primary component and the ambience component of each of the transformed stereo vocal signal and the transformed stereo non-vocal signal; rendering the primary component and the ambience component of each of the transformed stereo vocal signal and the transformed stereo non-vocal signal, to obtain the rendered primary signals and the rendered ambience signals corresponding to each of the stereo vocal signal and the stereo non-vocal signal; and performing Inverse Short-Time Fourier Transform (ISTFT) on the rendered primary signals and the rendered ambience signals corresponding to each of the stereo vocal signal and the stereo non-vocal signal to obtain the rendered vocal output and the rendered non-vocal output.

Clause 3. The method according to any one of clauses 1-2, wherein the rendering the primary component comprises: calculating a direction of a sound source based on spatial orientation information included in the primary component; determining two adjacent speakers for reproducing the sound source based on the spatial orientation information; and calculating signals assigned to each speaker of the two adjacent speakers.

Clause 4. The method according to any one of clauses 1-3, wherein the calculating the direction of the sound source comprises performing a gain estimation of the primary component.

Clause 5. The method according to any one of clauses 1-4, wherein the calculating the signals assigned to each speaker of the two adjacent speakers comprises calculating the signals assigned to each speaker based on a reconstruction matrix and a separation matrix.

Clause 6. The method according to any one of clauses 1-5, wherein the rendering the ambience component comprises convolving the ambience component in a left channel and a right channel respectively with different predetermined impulse responses to generate surround signals for surround channels.

Clause 7. The method according to any one of clauses 1-6, further comprising determining whether the speaker system is operating in a party mode or a karaoke mode.

Clause 8. In some embodiments, a speaker system comprising: a memory configured to store instructions; and a processor configured to perform the instructions to: receive stereo audio; perform vocal extraction on the stereo audio and outputting a stereo vocal signal and a stereo non-vocal signal; perform primary and ambience extraction (PAE) based rendering on the stereo vocal signal and the stereo non-vocal signal, respectively, to obtain a rendered vocal output and a rendered non-vocal output; and mix the rendered vocal output and the rendered non-vocal output to generate the multichannel audio.

Clause 9. The speaker system according to clause 8, wherein the processor is further configured to: perform Short-Time Fourier Transform (STFT) on the stereo vocal signal and the stereo non-vocal signal to obtain the transformed stereo vocal signal and the transformed stereo non-vocal signal; perform the PAE on the transformed stereo vocal signal and the transformed stereo non-vocal signal to obtain the primary component and the ambience component of each of the transformed stereo vocal signal and the transformed stereo non-vocal signal; render the primary component and the ambience component of each of the transformed stereo vocal signal and the transformed stereo non-vocal signal, to obtain the rendered primary signals and the rendered ambience signals corresponding to each of the stereo vocal signal and the stereo non-vocal signal; and perform Inverse Short-Time Fourier Transform (ISTFT) on the rendered primary signals and the rendered ambience signals corresponding to each of the stereo vocal signal and the stereo non-vocal signal to obtain the rendered vocal output and the rendered non-vocal output.

Clause 10. The speaker system according to any one of clauses 8-9, wherein the processor is further configured to: calculate a direction of a sound source based on spatial orientation information included in the primary component; determine two adjacent speakers for reproducing the sound source based on the spatial orientation information; and calculate signals assigned to each speaker of the two adjacent speakers.

Clause 11. The speaker system according to any one of clauses 8-10, wherein the processor is further configured to calculate the direction of the sound source by performing a gain estimation of the primary component.

Clause 12. The speaker system according to any one of clauses 8-11, wherein the processor is further configured to calculate the signals assigned to each speaker by calculating the signals assigned to each speaker of the two adjacent speakers based on a reconstruction matrix and a separation matrix.

Clause 13. The speaker system according to any one of clauses 8-12, wherein the processor is further configured to render the ambience component by convolving the ambience component in a left channel and a right channel respectively with different predetermined impulse responses to generate surround signals for surround channels.

Clause 14. The speaker system according to any one of clauses 8-13, wherein the speaker system comprises at least one control element that can be operated to control the speaker system to switch between a party mode and a karaoke mode.

Clause 15. In some embodiments, a computer-readable storage medium comprising computer-executable instructions which, when executed by a computer, causes the computer to perform the method according to any one of clauses 1-7.

1. A method of multichannel audio reconstruction for a speaker system comprising:
receiving stereo audio;
performing vocal extraction on the stereo audio and outputting a stereo vocal signal and a stereo non-vocal signal;
performing primary and ambience extraction (PAE) based rendering on the stereo vocal signal and the stereo non-vocal signal, respectively, to obtain a rendered vocal output and a rendered non-vocal output; and
mixing the rendered vocal output and the rendered non-vocal output to generate the multichannel audio.

2. The method according to claim 1, wherein the performing the PAE based rendering on the stereo vocal signal and the stereo non-vocal signal comprises:
performing Short-Time Fourier Transform (STFT) on the stereo vocal signal and the stereo non-vocal signal to obtain the transformed stereo vocal signal and the transformed stereo non-vocal signal;
performing the PAE on the transformed stereo vocal signal and the transformed stereo non-vocal signal to obtain a primary component and an ambience component of each of the transformed stereo vocal signal and the transformed stereo non-vocal signal;
rendering the primary component and the ambience component of each of the transformed stereo vocal signal and the transformed stereo non-vocal signal, to obtain the rendered primary signals and the rendered ambience signals corresponding to each of the stereo vocal signal and the stereo non-vocal signal; and
performing Inverse Short-Time Fourier Transform (ISTFT) on the rendered primary signals and the rendered ambience signals corresponding to each of the stereo vocal signal and the stereo non-vocal signal to obtain the rendered vocal output and the rendered non-vocal output.

3. The method according to claim 2, wherein the rendering the primary component comprises:
calculating a direction of a sound source based on spatial orientation information included in the primary component;
determining two adjacent speakers for reproducing the sound source based on the spatial orientation information; and
calculating signals assigned to each speaker of the two adjacent speakers.

4. The method according to claim 3, wherein the calculating the direction of the sound source comprises performing a gain estimation of the primary component.

5. The method according to claim 3, wherein the calculating the signals assigned to each speaker of the two adjacent speakers comprises calculating the signals assigned to each speaker based on a reconstruction matrix and a separation matrix.

6. The method according to claim 2, wherein the rendering the ambience component comprises convolving the ambience component in a left channel and a right channel respectively with different predetermined impulse responses to generate surround signals for surround channels.

7. The method according to claim 1, further comprising determining whether the speaker system is operating in a party mode or a karaoke mode.

8. A speaker system comprising:
a memory configured to store instructions; and
a processor configured to perform the instructions to:
receive stereo audio;
perform vocal extraction on the stereo audio and outputting a stereo vocal signal and a stereo non-vocal signal;
perform primary and ambience extraction (PAE) based rendering on the stereo vocal signal and the stereo non-vocal signal, respectively, to obtain a rendered vocal output and a rendered non-vocal output; and
mix the rendered vocal output and the rendered non-vocal output to generate multichannel audio.

9. The speaker system according to claim 8, wherein the processor is further configured to:
perform Short-Time Fourier Transform (STFT) on the stereo vocal signal and the stereo non-vocal signal to obtain the transformed stereo vocal signal and the transformed stereo non-vocal signal;
perform the PAE on the transformed stereo vocal signal and the transformed stereo non-vocal signal to obtain a primary component and an ambience component of each of the transformed stereo vocal signal and the transformed stereo non-vocal signal;
render the primary component and the ambience component of each of the transformed stereo vocal signal and the transformed stereo non-vocal signal, to obtain the rendered primary signals and the rendered ambience signals corresponding to each of the stereo vocal signal and the stereo non-vocal signal; and
perform Inverse Short-Time Fourier Transform (ISTFT) on the rendered primary signals and the rendered ambience signals corresponding to each of the stereo vocal signal and the stereo non-vocal signal to obtain the rendered vocal output and the rendered non-vocal output.

10. The speaker system according to claim 9, wherein the processor is further configured to:
calculate a direction of a sound source based on spatial orientation information included in the primary component;
determine two adjacent speakers for reproducing the sound source based on the spatial orientation information; and
calculate signals assigned to each speaker of the two adjacent speakers.

11. The speaker system according to claim 10, wherein the processor is further configured to calculate the direction of the sound source by performing a gain estimation of the primary component.

12. The speaker system according to claim 10, wherein the processor is further configured to calculate the signals assigned to each speaker by calculating the signals assigned to each speaker of the two adjacent speakers based on a reconstruction matrix and a separation matrix.

13. The speaker system according to claim 9, wherein the processor is further configured to render the ambience component by convolving the ambience component in a left channel and a right channel respectively with different predetermined impulse responses to generate surround signals for surround channels.

14. The speaker system according to claim 8, wherein the speaker system comprises at least one control element that can be operated to control the speaker system to switch between a party mode and a karaoke mode.

15. A non-transitory computer-readable storage medium comprising computer-executable instructions which, when executed by a computer, causes the computer to perform operations including to:
receive stereo audio;
perform vocal extraction on the stereo audio and outputting a stereo vocal signal and a stereo non-vocal signal;
perform primary and ambience extraction (PAE) based rendering on the stereo vocal signal and the stereo non-vocal signal, respectively, to obtain a rendered vocal output and a rendered non-vocal output; and
mix the rendered vocal output and the rendered non-vocal output to generate the multichannel audio.

16. The non-transitory computer-readable storage medium according to claim 15, wherein to perform the PAE based rendering on the stereo vocal signal and the stereo non-vocal signal comprises to:
perform Short-Time Fourier Transform (STFT) on the stereo vocal signal and the stereo non-vocal signal to obtain the transformed stereo vocal signal and the transformed stereo non-vocal signal;
perform the PAE on the transformed stereo vocal signal and the transformed stereo non-vocal signal to obtain a primary component and an ambience component of each of the transformed stereo vocal signal and the transformed stereo non-vocal signal;
render the primary component and the ambience component of each of the transformed stereo vocal signal and the transformed stereo non-vocal signal, to obtain the rendered primary signals and the rendered ambience signals corresponding to each of the stereo vocal signal and the stereo non-vocal signal; and
perform Inverse Short-Time Fourier Transform (ISTFT) on the rendered primary signals and the rendered ambience signals corresponding to each of the stereo vocal signal and the stereo non-vocal signal to obtain the rendered vocal output and the rendered non-vocal output.

17. The non-transitory computer-readable storage medium according to claim 16, wherein to render the primary component comprises to:
calculate a direction of a sound source based on spatial orientation information included in the primary component;
determine two adjacent speakers for reproducing the sound source based on the spatial orientation information; and
calculate signals assigned to each speaker of the two adjacent speakers.

18. The non-transitory computer-readable storage medium according to claim 17, wherein to calculate the direction of the sound source comprises performing a gain estimation of the primary component.

19. The non-transitory computer-readable storage medium according to claim 17, wherein to calculate the signals assigned to each speaker of the two adjacent speakers comprises to calculate the signals assigned to each speaker based on a reconstruction matrix and a separation matrix.

20. The non-transitory computer-readable storage medium according to claim 16, wherein to render the ambience component comprises to convolve the ambience component in a left channel and a right channel respectively with different predetermined impulse responses to generate surround signals for surround channels.
